(19) United States
(12) Patent Application Publication
(10) Pub. No.: US 2007/0150094 A1
(43) Pub. Date: Jun. 28, 2007

(54) System and method for planning and indirectly guiding robotic actions based on external factor tracking and analysis

(76) Inventors: Qingfeng Huang, San Jose, CA (US); James E. Reich, San Francisco, CA (US); Patrick C. Cheung, Castro Valley, CA (US)

Correspondence Address: CASCADIA INTELLECTUAL PROPERTY, 500 UNION STREET, SUITE 1005, SEATTLE, WA, 98101, US

(21) Appl. No.: 11/317,732

(22) Filed: Dec. 23, 2005

(51) Int. Cl. G06F 19/00

(52) U.S. Cl. 700/245

(57) ABSTRACT

A system and method for guiding robotic actions based on external factor tracking and analysis is presented. External factors affecting a defined physical space are tracked through a stationary environmental sensor. The external factors are analyzed to determine one or more of activity levels and usage patterns occurring within the defined physical space. At least one of movements and actions to be performed by a mobile effector that operates untethered from the stationary environmental sensor within the defined physical space are determined. The movements and actions are autonomously executed in the defined physical space through the mobile effector.

### FIELD

This application relates in general to robotic guidance and, in particular, to a system and method for planning and indirectly guiding robotic actions based on external factor tracking and analysis.

### BACKGROUND

Robotic control includes providing mobile effectors, or robots, with data necessary to autonomously move and perform actions within an environment. Movement can be self-guided using, for instance, environmental sensors for determining relative location within the environment. Frequently, movement is coupled with self-controlled actions to perform a task, such as cleaning, sensing, or directly operating on the environment.

Conventionally, self-guided robots use self-contained on-board guidance systems, which can include environmental sensors to track relative movement, detect collisions, identify obstructions, or provide an awareness of the immediate surroundings. Sensor readings are provided to a processor that executes control algorithms over the sensor readings to plan the next robotic movement or function to be performed. Movement can occur in a single direction or could be a sequence of individual movements, turns, and stationary positions.

Two forms of navigation are commonly employed in self-guided robots. “Dead reckoning” navigation employs movement coupled with obstruction avoidance or detection. Guided navigation employs movement performed with reference to a fixed external object, such as a ceiling or stationary marker. Either form of navigation can be used to guide a robot's movements. In addition, stationary markers can be used to mark off an area as an artificial boundary.

Dead reckoning and guided navigation allow a robot to move within an environment. However, guidance and, consequently, task completion, are opportunistic because the physical operating environment is only discovered by chance, that is, as exploration of the environment progresses. For example, a collision would teach a robot of the presence of an obstruction. Opportunistically-acquired knowledge becomes of less use over time, as non-fixed objects can move to new locations and the robot has to re-learn the environment. Moreover, opportunistic discovery does not allow a robot to observe activities occurring within the environment when the robot is idle.

Continually tracking activity levels and usage patterns occurring within an environment from a temporal perspective can help to avoid robotic movement inefficiencies. For example, interim changes affecting the environment between robotic activations can permit task planning of coverage area and task performance frequency. Furthermore, opportunistic discovery does not provide information sufficient to allow efficient task planning. The single perspective generated by an individual robot affords only a partial view of the environment of limited use in coordinating the actions of a plurality of robots for efficient multitasking behavior.

Therefore, there is a need for tracking temporally-related factors occurring in an environment for planning task execution of one or more self-guided robots to provide efficient movement and control.

### SUMMARY

A system and method for planning and indirectly guiding the actions of robots within a two-dimensional planar or three-dimensional surface projection of an environment. The environment is monitored from a stationary prospective continually, intermittently, or as needed and monitoring data is provided to a processor for analysis. The processor identifies levels of activity and patterns of usage within the environment, which are provided to a robot that is configured to operate within the environment. The processor determines those areas within the environment that require the attention of the robot and the frequency with which the robot will visit or act upon those areas. In one embodiment, the environment is monitored through visual means, such as a video camera, and the processor can be a component separate from or integral to a robot. The robot and monitoring means operate in an untethered fashion.

One embodiment provides a system and method for guiding robotic actions based on external factor tracking and analysis. External factors affecting a defined physical space are tracked through a stationary environmental sensor. The external factors are analyzed to determine one or more of activity levels and usage patterns occurring within the defined physical space. At least one of movements and actions to be performed by a mobile effector that operates untethered from the stationary environmental sensor within the defined physical space are determined. The movements and actions are autonomously executed in the defined physical space through the mobile effector.

A further embodiment provides a system and method for planning and indirectly guiding robotic actions based on external factors and movements and actions. A mobile effector that operates untethered within a defined physical space is provided. External factors affecting the defined physical space and movements and actions performed by the mobile effector in the defined physical space are tracked through a stationary environmental sensor. The external factors and the movements and actions are analyzed to determine activity levels and usage patterns occurring within the defined physical space. Further movements and actions to be performed by the mobile effector are planned based on the activity levels and usage patterns. The further movements and actions are communicated to the mobile effector for autonomous execution

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing, by way of example, components for planning and indirectly guiding robotic actions based on external factor tracking and analysis, in accordance with one embodiment.

FIG. 2 is a process flow diagram showing an observation mode performed by the components of FIG. 1.

FIG. 3 is a process flow diagram showing an action mode performed by the components of FIG. 1.

FIG. 4 is a functional block diagram showing the processor of FIG. 1.

FIG. 5 is a diagram showing, by way of example, an environment logically projected onto a planar space within which to plan and indirectly guide robotic movements and actions.

FIG. 6 is a diagram showing, by way of example, activities and usage within the environment of FIG. 5.

FIG. 7 is a diagram showing, by way of example, a three-dimensional histogram of activities tracked within the environment of FIG. 5.

FIG. 8 is a diagram showing, by way of example, a three-dimensional histogram of usage tracked within the environment of FIG. 5.

FIG. 9 is a diagram showing, by way of example, a three-dimensional histogram of mean external factors tracked within the environment of FIG. 5.

FIGS. 10, 11, and 12 are diagrams showing, by way of example, maps for operations to be performed in the environment of FIG. 5.

### DETAILED DESCRIPTION

Components

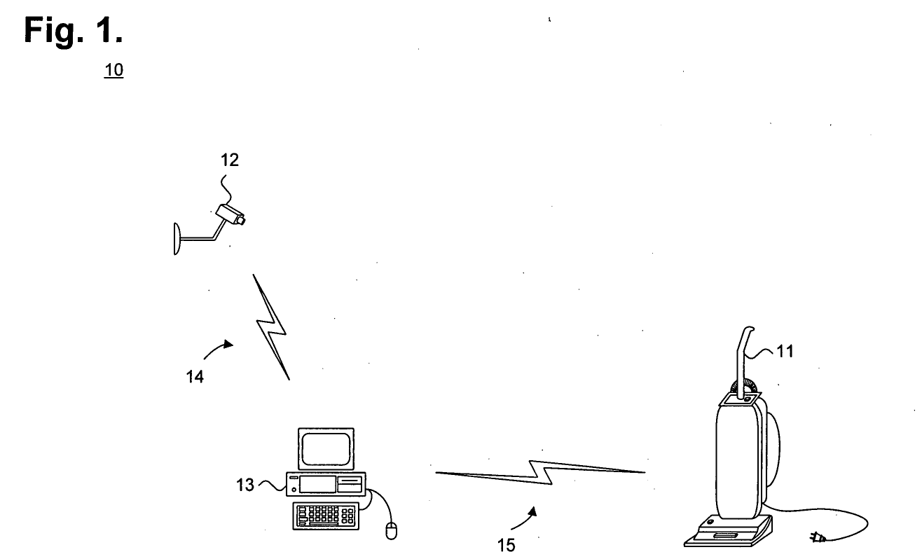

Each mobile effector, or robot, is capable of autonomous movement in any direction within an environment under the control of on-board guidance. Robotic actions necessary to perform a task are also autonomously controlled. Robotic movement may be remotely monitored, but physical movements and actions are self-controlled. FIG. 1 is a block diagram showing, by way of example, components 10 for planning and indirectly guiding robotic actions based on external factor tracking and analysis, in accordance with one embodiment. A self-guided mobile robot 11 that can autonomously move and perform a function is operatively coupled to a processor 13. In turn, the processor 13 is communicatively interfaced to an environmental sensor, such as a video camera 12, that generates a global perspective of the environment. The environment is a physical space, which can be logically defined as a two-dimensional planar space or three-dimensional surface space within which the robot 11 moves and operates.

The robot 11 and video camera 12 are physically separate untethered components. The robot 11 is mobile while the video camera 12 provides a stationary perspective. The processor 13 can either be separate from or integral to the robot 11 and functions as an intermediary between the video camera 12 and the robot 11. In one embodiment, the processor 13 is a component separate from the robot 11. The processor 13 is interfaced to the video camera 12 either through a wired or wireless connection 14 and to the robot 11 through a wireless connection 15. Video camera-to-processor connections 14 include both digital, such as serial, parallel, or packet-switched, and analog, such as CYK signal lead, interconnections. Processor-to-robot connections 15 include bi-directional interconnections. Serial connections include RS-232 and RS-422 compliant interfaces and parallel connections include Bitronics compliant interfaces. Packet-switched connections include Transmission Control Protocol/Interface Protocol (TCP/IP) compliant network interfaces, including IEEE 802.3 (“Ethernet”) and 802.11 (“WiFi”) standard interconnections. Other types of wired and wireless interfaces, both proprietary and open standard, are possible.

The robot 11 includes a power source, motive power, a self-contained guidance system, and an interface to the processor 13, plus components for performing a function within the environment. The motive power moves the mobile robot 12 about the environment. The navigation system guides the robot 11 autonomously within the environment and can navigate the robot 11 in a direction selected by or to a marker identified by the processor 13 based on an analysis of video camera observations data and robot feedback. In a further embodiment, the robot 11 can also include one or more video cameras (not shown) to supply live or recorded observation data to the processor 13 as feedback, which can be used to plan and indirectly guide further robotic actions. Other robot components are possible.

The video camera 12 actively senses the environment from a stationary position, which can include a ceiling, wall, floor, or other surface, and the sensing can be in any direction that the video camera 12 is capable of observing in either two or three dimensions. The video camera 12 can provide a live or recorded video feed, series of single frame images, or other form of observation or monitoring data. The video camera 12 need not be limited to providing visual observation data and could also provide other forms of environment observations or monitoring data. However, the video camera 12 must be able to capture changes that occur in the environment due to the movement and operation of the robot 12 and external factors acting upon the environment, including, for example, the movements or actions of fixed and non-fixed objects that occur within the environment over time between robot activations. The video camera 12 can directly sense the changes of objects or indirectly sense the changes by the effect made on the environment or on other objects. Direct changes, for instance, include differences in robot position or orientation and indirect changes include, for example, changes in lighting or shadows. The video camera 12 can monitor the environment on either a continual or intermittent basis, as well as on-demand of the processor 13. The video camera 12 includes an optical sensor, imagery circuitry, and an interface to the processor 13. In a further embodiment, the video camera 12 can include a memory for transiently storing captured imagery, such as a frame buffer. Other video camera components, as well as other forms of cameras or environment monitoring or observation devices, are possible.

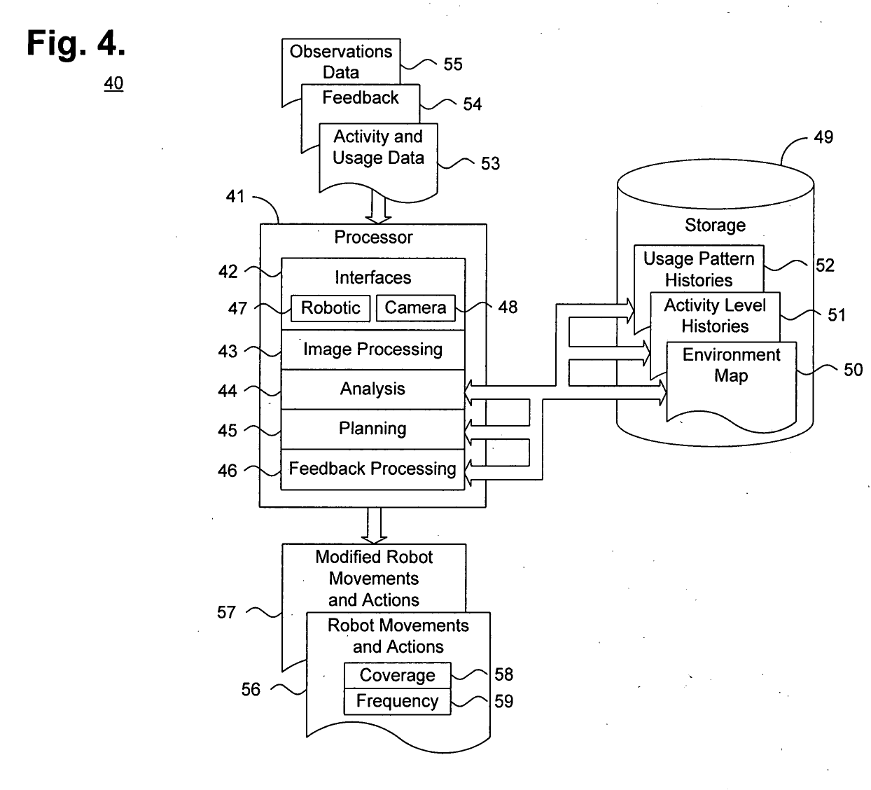

The processor 13 analyzes the environment as visually tracked in the observation data by the video camera 12 to plan and remotely guide movement and operation of the robot 11. The processor 13 can be separate from or integral to the robot 11 and includes a central processing unit, memory, persistent storage, and interfaces to the video camera 12 and robot 11. The processor 13 includes functional components to analyze the observation data and to indirectly specify, verify, and, if necessary, modify robotic actions, as further described below with reference to FIG. 4. The processor 13 can be configured for operation with one or more video cameras 12 and one or more robots 11. Similarly, multiple processors 13 can be used in sequence or in parallel. Other processor components are possible.

Preferably, the processor 13 is either an embedded micro programmed system or a general-purpose computer system, such as a personal desktop or notebook computer. In addition, the processor 13 is a programmable computing device that executes software programs and includes, for example, a central processing unit (CPU), memory, network interface, persistent storage, and various components for interconnecting these components.

Observation and Action Modes

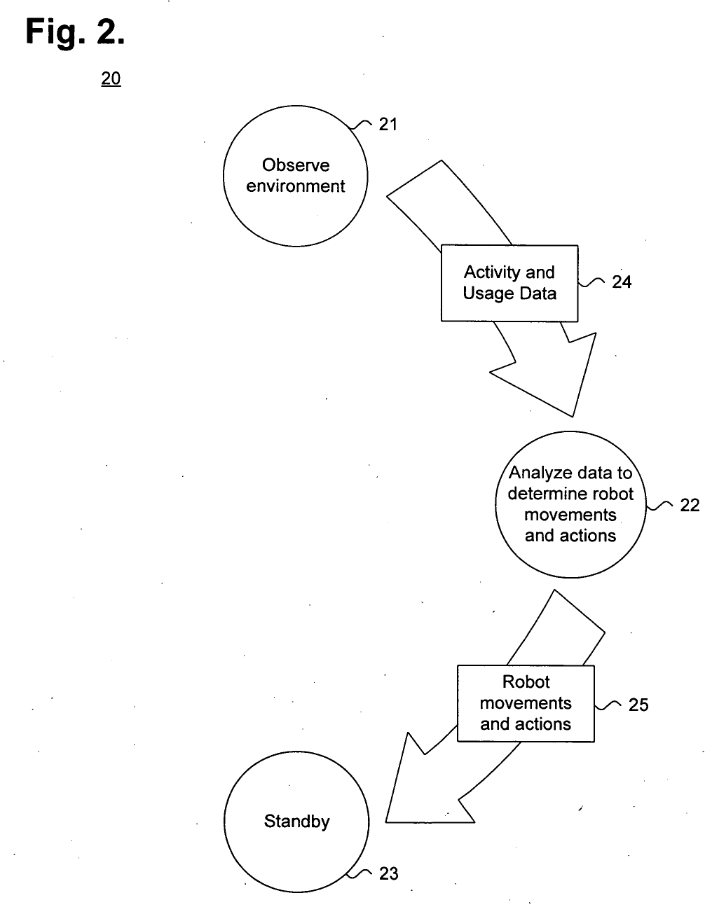

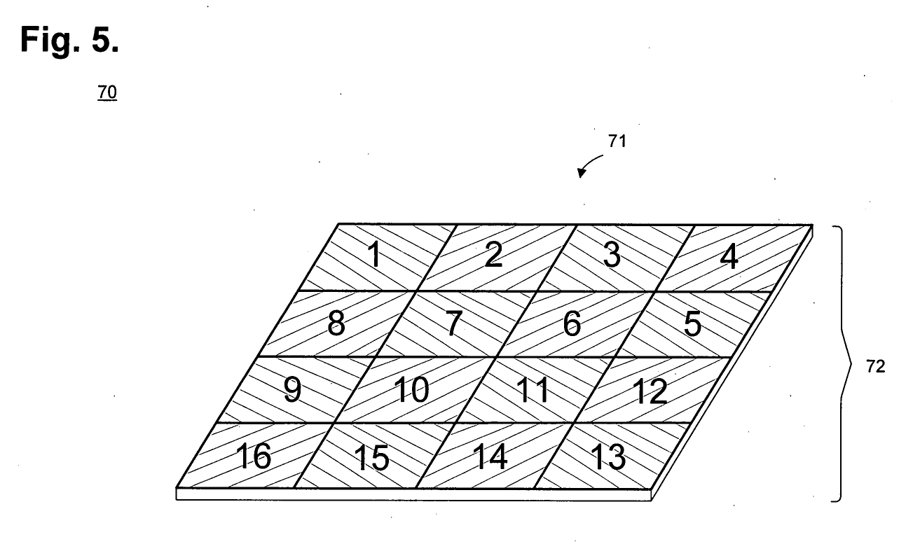

Robotic actions are planned and indirectly guided through observation and action modes of operation. For ease of discussion, planning and indirect guidance are described with reference to two dimensional space, but applies equally to three dimensional space mutatis mutandis. FIG. 2 is a process flow diagram showing an observation mode 20 performed by the components 10 of FIG. 1. During observation mode 20, the video camera 12 and processor 13 are active, while the robot 11 is in a standby mode. The video camera 12 observes the environment (operation 21) by continually, intermittently, or as required, monitoring levels of activity and patterns of usage within the environment. Other types of occurrences could be monitored. Periodically, or on a continuing basis, activity and usage data 24 is provided from the video camera 12 to the processor 13, which analyzes the data to determine where the robot will move or act within the environment and the frequency with which such robot movements or actions 25 will occur (operation 22), as further described below, by way of example, with reference to FIGS. 5 et seq. The robot 11 can receive the robot movements and actions 25 while in standby mode (operation 23). Other operations during observation mode 20 are possible.

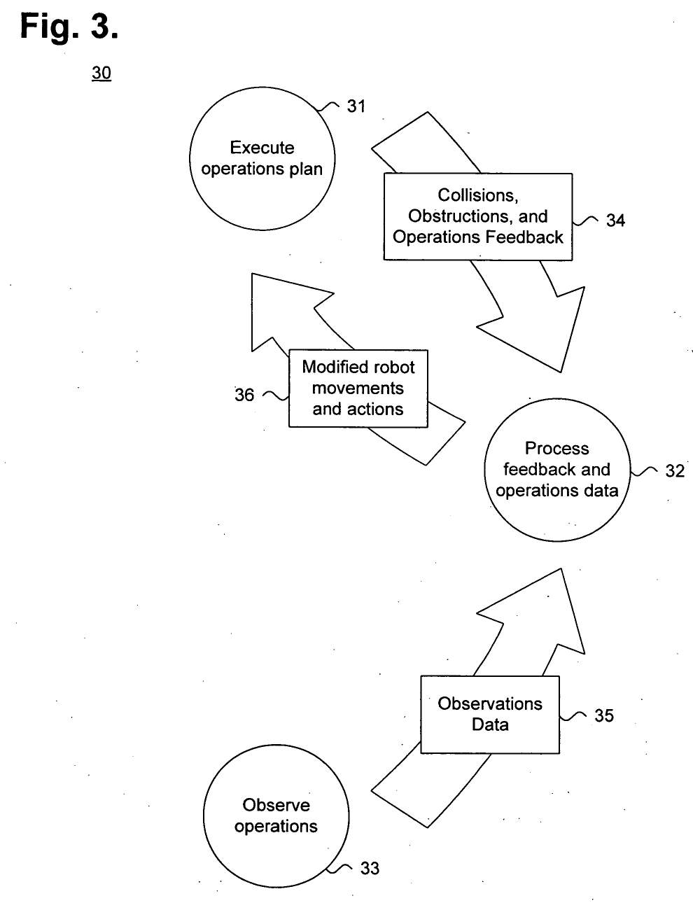

FIG. 3 is a process flow diagram showing an action mode 30 performed by the components 10 of FIG. 1. During action mode, all components are active. The robot 11 executes the robot movements and actions 25 autonomously within the environment (operation 31) over the areas and at the frequencies determined by the processor 13. In a further embodiment, the robot 11 generates feedback 34 from on-board sensors, which can include data describing collisions, obstructions, and other operational information, that is provided to and processed by the processor 13 (operation 32). Additionally, the video camera 12 observes the operations executed by the robot 11 (operation 33) and provides observations data 35 to the processor 13 for processing (operation 32). The processor 13 can use the feedback 34 and observations data 35 to verify the execution and to modify the robot movements and actions 36. Modifications might address, for instance, unexpected obstacles or changes to the functions to be performed by the robot 11. For example, a closed door or particularly dirty surface might require changes to respectively curtail those operations that would have been performed behind the now-closed door or to increase the frequency or thoroughness with which the newly-discovered dirty surface is cleaned. Other types of action mode operations are possible.

Processor

The processor can be a component separate from or integral to the robot. The same functions are performed by the processor independent of physical location. The movements and actions performed by a plurality of robots 11 can be guided by a single processor using monitoring data and feedback provided by one or more video cameras 12. FIG. 4 is a functional block diagram showing the processor 41 of FIG. 1. The processor 41 includes a set of functional modules 42-48 and a persistent storage 49. Other processor components are possible.

The processor 41 includes at least two interfaces 42 for robotic 47 and camera 48 communications. The processor 41 receives activity and usage data 53 and observations data 55 through the camera interface 48. The processor 41 also receives feedback 54 and sends robot movements and actions 56 and modified robot movements and actions 57 through the robotic interface 47. If the processor 41 is implemented as a component separate from the robot, the robotic interface 47 is wireless to allow the robot to operate in an untethered fashion. The camera interface 48, however, can be either wireless or wired. If the processor 41 is implemented as a component integral to the robot, the robotic interface 47 is generally built-in and the camera interface 48 is wireless. Other forms of interfacing are possible, provided the robot operates in an autonomous manner without physical, that is wired, interconnection with the video camera.

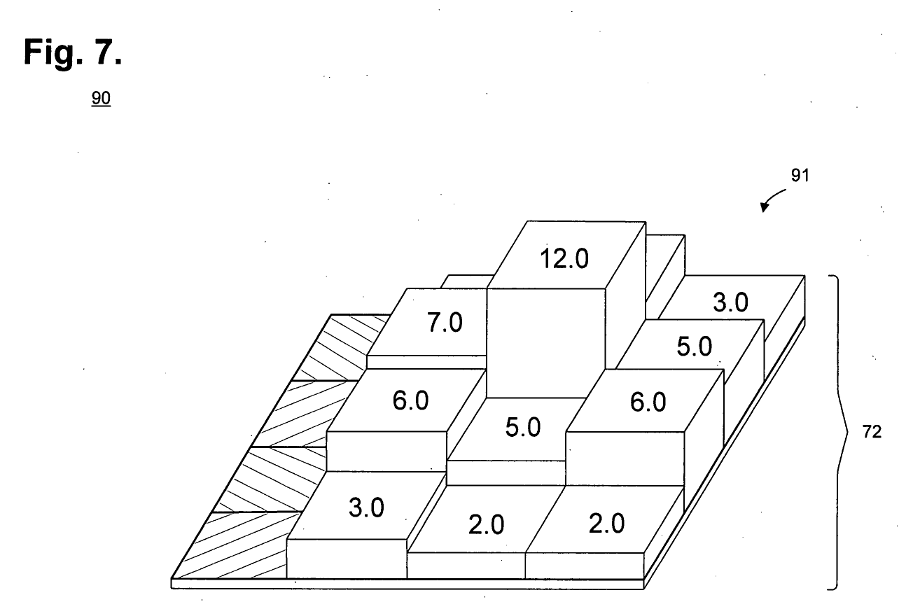

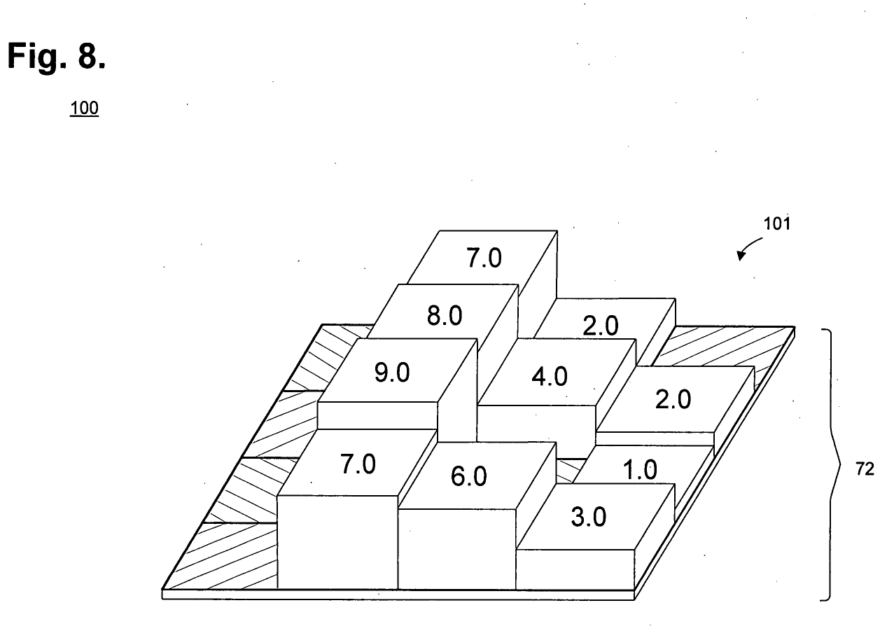

The image processing module 43 receives the activity and usage data 53 and observations data 55 from the video camera 12. These data sets are analyzed by the processor 41 to respectively identify activity levels and usage patterns during observation mode 20 and robotic progress during action mode 30. One commonly-used image processing technique to identify changes occurring within a visually monitored environment is to identify changes in lighting or shadow intensity by subtracting video frames captured at different times. Any differences can be analyzed by the analysis module 44 to identify activity level, usage patterns, and other data, such as dirt or dust accumulation. The activity level and usage patterns can be quantized and mapped into histograms projected over a two-dimensional planar space or three-dimensional surface space, such as further described below respectively with reference to FIGS. 7 and 8. A legacy of observed activity levels and usage patterns can be maintained in the storage 49 as activity level histories 59 and usage pattern histories 52.

The activity levels and usage patterns are used by the planning module 45 to robot movements and actions 56 that specify the areas of coverage 58 and frequencies of operation 59, for instance, cleaning, to be performed by the robot 12 within the environment. Although movements and actions are provided to the robot 12 by the processor 41, physical robotic operations are performed autonomously. The planning module 45 uses a stored environment map 50 that represents the environment in two dimensions projected onto a planar space or in three dimensions projected onto a surface space. In a further embodiment, the robot sends feedback 54, which, along with the observations data 55, the feedback processing module 46 uses to generate modified robot movements and actions 57. Other processor modules are possible.

Environment Example

The robot 11, video camera 12, and processor 13 function as a logically unified system to plan and indirectly guide robotic actions within an environment. The physical environment over which a robot can operate under the planning and guidance of a processor is logically represented as a two-dimensional planar space or as a three-dimensional surface space that represents the area monitored by a video camera. FIG. 5 is a diagram 70 showing, by way of example, an environment 72 logically projected onto a planar space 71 within which to plan and indirectly guide robotic movements and actions. For convenience, the planar space 71 is represented by a grid of equal-sized squares sequentially numbered in increasing order. However, the planar space can be represented through other forms of relative and absolute linear measure, including Cartesian and polar coordinates and geolocational data.

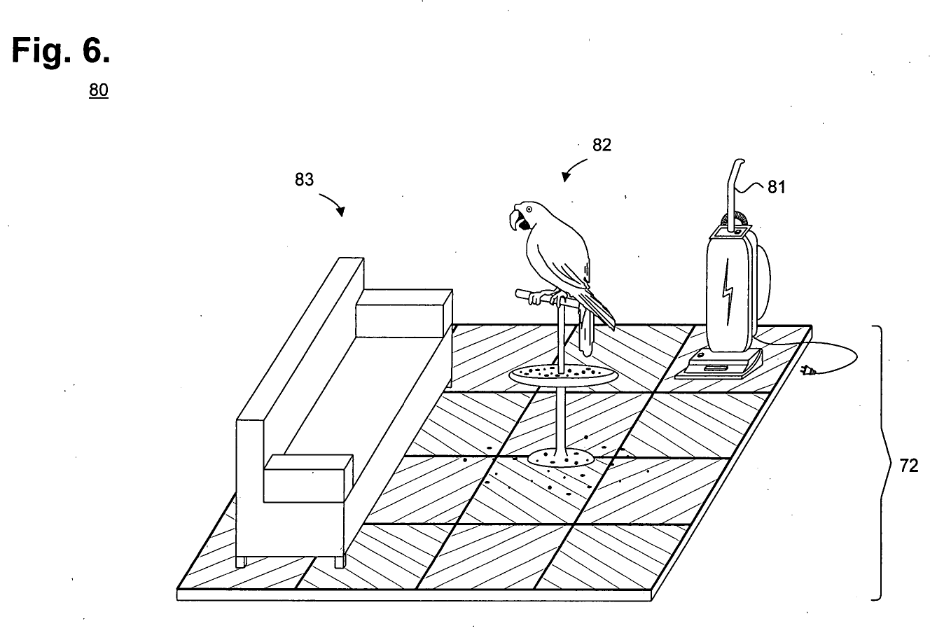

The environment 72 provides a defined physical space mappable into two dimensions and over which a robot can move and function. FIG. 6 is a diagram 80 showing, by way of example, activities and usage within the environment 72 of FIG. 5. A robot 81 can be pre-positioned within or situated outside of the environment 72. Although the robot 11 can operate outside of the monitored environment, the movements and actions would be performed independent of the planning and guidance provided by the video camera 12 and processor 13. Consequently, planning and guidance are limited to the logically-defined two-dimensional planar space or the three-dimensional surface space of the environment monitored by the video camera 12. In a further embodiment, two or more video cameras 12 can be used to extend the environment and the robot 11 can operate within the extended environment monitored by any of the video cameras 12, either singly or in combination. The robot 11 could further cross over between each of the separate “territories” monitored by the individual video cameras 12, even where robotic movement would involve temporarily leaving the monitored environment.

The environment 72 can contain both dynamic moving objects 82 and static stationary objects 83 in either two or three dimensions. For instance, two-dimensional observation data from the video camera 12 can be used to plan the vacuuming of a floor or couch. Similarly, three-dimensional observation data can be used to assist the robot 11 in climbing a set of stairs or paint the walls. Two- and three-dimensional data can be used together or separately.

Generally, the processor 13 will recognize the stationary objects 83 as merging into the background of the planar space, while the moving objects 82 can be analyzed for temporally-changing locations, that is, activity level, and physically-displaced locations, that is, patterns of usage or movement.

By comparing subsequent frames of video feed that include a reference background frame, the processor 13 can identify changes occurring within the environment 72 over time. FIG. 7 is a diagram 90 showing, by way of example, a three-dimensional histogram of activities 91 tracked within the environment 72 of FIG. 5. Temporally-occurring changes of moving objects 82 within the environment 72 represent the relative level of activity occurring within the environment 72. The frequencies of occurrences of movements and actions can be quantized and, for instance, plotted in a histogram 91 that represents the relative levels of activities that have occurred since the most-recent, or earlier, monitoring. FIG. 8 is a diagram 100 showing, by way of example, a three-dimensional histogram of usage 101 tracked within the environment 72 of FIG. 5. Usage can be monitored by visually observing the movement or actions of objects, primarily moving objects 82 but, to a lesser degree, stationary objects 83, within the environment 72. Activities occurring across different regions within an environment can collectively show patterns of usage.

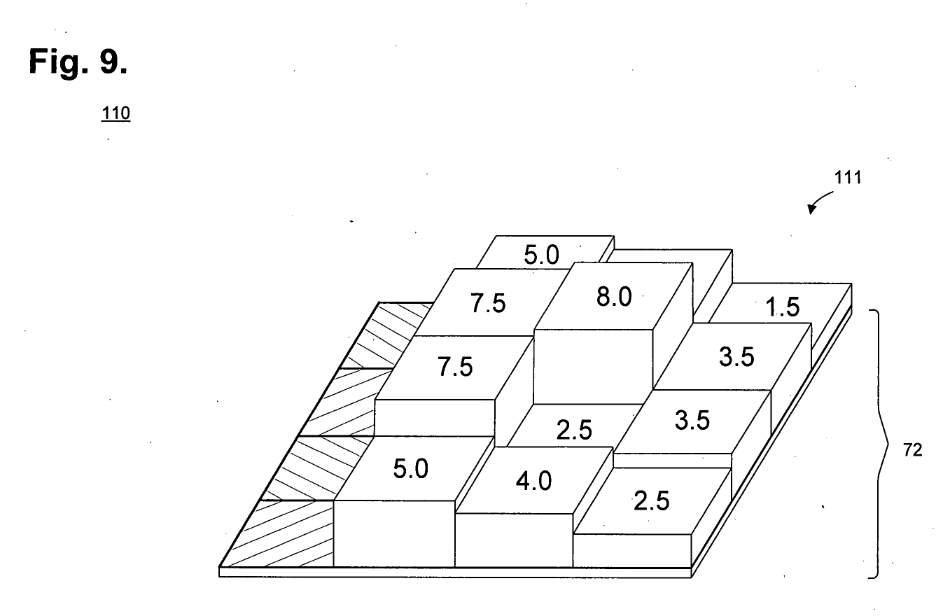

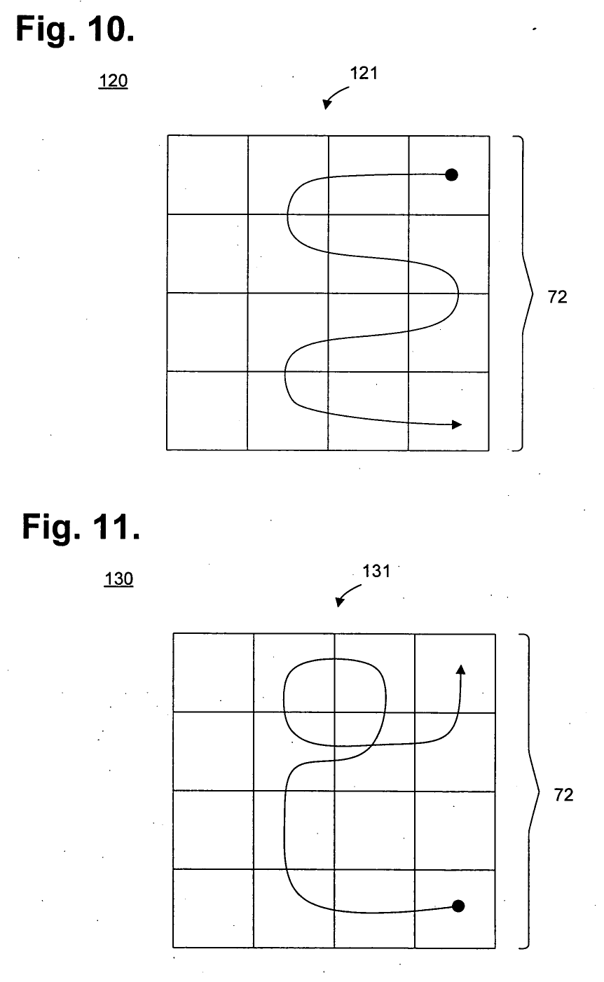

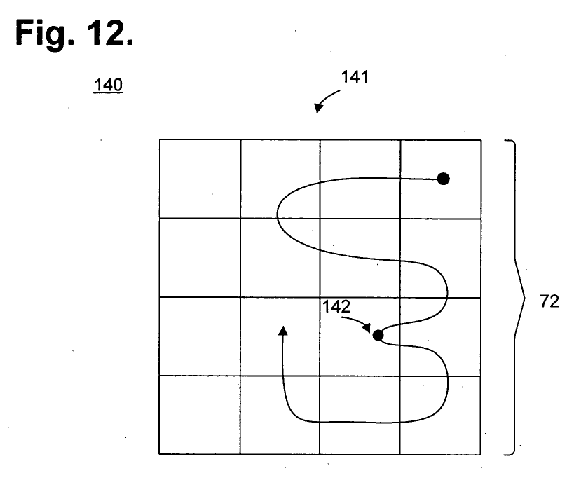

Both the level of activity and patterns of usage can be evaluated to determine movements and actions for the robot. FIG. 9 is a diagram 110 showing, by way of example, a three-dimensional histogram of mean external factors 111 tracked within the environment 72 of FIG. 5. For example, the mean of the activity levels 91 and usage patterns 101 for each corresponding region of the environment 72 can be plotted to identify those areas within the environment 72 over which the robot will operate. FIGS. 10, 11, and 12 are diagrams 120, 130, 140 showing, by way of example, maps 121, 131, 141 for operations to be performed in the environment 72 of FIG. 5. For example, those areas of the environment 72 that have remained unused, at least since the last monitoring, can be ignored by the robot. Referring first to FIG. 10, a route 121 through the environment 72 can be mapped to cause the robot 11 to move through those areas falling within a pattern of usage. Similarly, the frequency with which an area is visited by a robot 11 can be scheduled to occur more often as the activity level increases. For instance, those areas with high levels of activity can be visited repeatedly during the same set of operations to provide the robot with sufficient time to perform the operations needed, such as, cleaning. Referring next to FIG. 11, a follow-up route 131 for re-visiting areas of particularly high levels of activity can be provided to ensure adequate attention by the robot 11. As a further example, the robot 11 and video camera 12 can respectively provide feedback and observations data to the processor 13 to verify and, if necessary, modify robotic operations. Referring finally to FIG. 12, while performing the operations plan described above with reference to FIG. 10, the robot encounters an obstacle at point 142, which is relayed to the processor 13 as feedback 34. By evaluating the feedback along with observations data received from the video camera 12, the processor 13 can modify the robot movements and actions to allow the robot to avoid the obstacle and complete the task assigned. Other forms of routes are possible.

While the invention has been particularly shown and described as referenced to the embodiments thereof, those skilled in the art will understand that the foregoing and other changes in form and detail may be made therein without departing from the spirit and scope.

What is claimed is:

1. A system for planning and indirectly guiding robotic actions based on external factor tracking and analysis, comprising:
an observation device to track external factors affecting a defined physical space through a stationary environmental sensor; and
a processor, comprising:
an analyzer to analyze the external factors to determine one or more of activity levels and usage patterns occurring within the defined physical space; and
a planner to determine at least one of movements and actions to be performed by a mobile effector that operates untethered from the stationary environmental sensor within the defined physical space, wherein the movements and actions are autonomously executed in the defined physical space through the mobile effector.

2. A system according to claim 1, wherein the tracking is performed on at least one of a continual, intermittent, and on-demand basis.

3. A system according to claim 1, wherein the movements and actions are defined to include at least one of coverage of movement or action and frequency of movement or action within the defined physical space.

4. A system according to claim 1, wherein the observation device is further configured to track the movements and actions performed by the mobile effector through the stationary environmental sensor and the processor is further configured to process at least one of verifying the movements and actions based on the tracking; and modifying the movements and actions based on the tracking.

5. A system according to claim 1, wherein the processor is further configured to process at least one of observation data provided by the stationary environmental sensor and feedback provided by the mobile effector while the movements and actions are performed by the mobile effector.

6. A system according to claim 1, wherein the actions are selected from the group comprising cleaning, sensing, and directly operating on the defined physical space.

7. A system according to claim 1, wherein the stationary environmental sensor comprises a video camera.

8. A method for planning and indirectly guiding robotic actions based on external factor tracking and analysis, comprising:
tracking external factors affecting a defined physical space through a stationary environmental sensor;
analyzing the external factors to determine one or more of activity levels and usage patterns occurring within the defined physical space;
determining at least one of movements and actions to be performed by a mobile effector that operates untethered from the stationary environmental sensor within the defined physical space; and
autonomously executing the movements and actions in the defined physical space through the mobile effector.

9. A method according to claim 8, further comprising:
performing the tracking on at least one of a continual, intermittent, and on-demand basis.

10. A method according to claim 8, further comprising:
defining the movements and actions to include at least one of coverage of movement or action and frequency of movement or action within the defined physical space.

11. A method according to claim 8, further comprising:
tracking the movements and actions performed by the mobile effector through the stationary environmental sensor; and
processing, comprising at least one of:
verifying the movements and actions based on the tracking; and
modifying the movements and actions based on the tracking.

12. A method according to claim 8, further comprising:
processing at least one of observation data provided by the stationary environmental sensor and feedback provided by the mobile effector while the movements and actions are performed by the mobile effector.

13. A method according to claim 8, wherein the actions are selected from the group comprising cleaning, sensing, and directly operating on the defined physical space.

14. A method according to claim 8, wherein the stationary environmental sensor comprises a video camera.

15. A computer-readable storage medium holding code for performing the method according to claim 8.

16. A system for planning and indirectly guiding robotic actions based on external factors and movements and actions, comprising:
a mobile effector that operates untethered within a defined physical space;
an observation device to track external factors affecting the defined physical space and movements and actions performed by the mobile effector in the defined physical space through a stationary environmental sensor;
an analyzer to analyze the external factors and the movements and actions to determine activity levels and usage patterns occurring within the defined physical space;
a planner to plan further movements and actions to be performed by the mobile effector based on the activity levels and usage patterns; and
an interface to communicate the further movements and actions to the mobile effector for autonomous execution.

17. A system according to claim 16, further comprising:
a verifier to verify the further movements and actions of the mobile effector based on the tracking during further planning.

18. A system according to claim 16, wherein the tracking is performed on at least one of a continual, intermittent, and on-demand basis.

19. A system according to claim 16, wherein the analyzer is further configured to analyze observation data provided by the stationary environmental sensor and feedback provided by the mobile effector while the further movements and actions are performed by the mobile effector.

20. A system according to claim 16, wherein the defined physical space is represented by at least one of a two-dimensional planar projection or a three-dimensional surface projection.

21. A method for planning and indirectly guiding robotic actions based on external factors and movements and actions, comprising:
providing a mobile effector that operates untethered within a defined physical space;
tracking through a stationary environmental sensor external factors affecting the defined physical space and movements and actions performed by the mobile effector in the defined physical space;
analyzing the external factors and the movements and actions to determine activity levels and usage patterns occurring within the defined physical space;
planning further movements and actions to be performed by the mobile effector based on the activity levels and usage patterns; and
communicating the further movements and actions to the mobile effector for autonomous execution.

22. A method according to claim 21, further comprising:
verifying the further movements and actions of the mobile effector based on the tracking during further planning.

23. A method according to claim 21, further comprising:
performing the tracking on at least one of a continual, intermittent, and on-demand basis.

24. A method according to claim 21, further comprising:
analyzing observation data provided by the stationary environmental sensor and feedback provided by the mobile effector while the further movements and actions are performed by the mobile effector.

25. A method according to claim 21, wherein the defined physical space is represented by at least one of a two-dimensional planar projection or a three-dimensional surface projection.

26. A computer-readable storage medium holding code for performing the method according to claim 21.
